(19) United States
(12) Patent Application Publication
(10) Pub. No.: US 2007/0110930 A1
(43) Pub. Date: May 17, 2007

(54) Educational cups and game sets

(76) Inventors: Carol G. Janet, Atlanta, GA (US); Nadia Bilchik Kesler, Atlanta, GA (US)

Correspondence Address: Harry I. Leon, 924 Bowen St., NW, Atlanta, GA, 30318, US

(21) Appl. No.: 11/280,381

(22) Filed: Nov. 16, 2005

(51) Int. Cl. B32B 27/10

(52) U.S. Cl. 428/34.2; 428/34.1

(57) ABSTRACT

Educational cups and game sets for children's play. A disposable cup includes a printed material on its side such that the printed material is right side up when the cup is upside down. A game set includes a plurality of the educational cups and a mat having corresponding printed materials such that a player could match the printed materials on the cups with the printed materials on the mat.

### FIELD OF THE INVENTION

This invention relates to cups for play and education.

### BACKGROUND OF THE INVENTION

Every parent or caregiver has been in the situation where he or she has found it difficult to keep young children occupied and stimulated. The ubiquitous challenge to keep young children engaged in interesting activities surfaces in visits to doctors, friends, restaurants, home, in short, almost everywhere.

Embodiments according to the present invention help to keep young children in affordable, fun and educational activities for hours, thereby providing interactive alternate solutions to passive activities such as watching television.

### SUMMARY

The present invention provides educational and fun play cups for keeping young children at an interactive activity. A cup according to the present invention includes a printed material on its side such that the printed material is right side up when the cup is upside down.

In use, a child plays a plurality of cups according to the present invention, and thus engages with a plurality of printed materials shown on the cups. Using the printed materials on the cups as a guide, the child may stack, sort, match, and arrange the cups. The printed material are fun and educational, thus the child's attention may be engaged in educational process while he or she is playing with the cups.

A game set according to the present invention includes a plurality of cups according to the present invention and a mat having a plurality of printed materials. The printed materials on the plurality of cups comprise a first series of printed material, while the plurality of printed materials on the mat comprises a second series of printed materials. A child may be engaged to identify, sort and match an item in the first series to the corresponding item in the second series.

Cups and game sets according to the present invention enable numerous educational and fun activities, such as, among other things, spelling words, making phrases, counting numbers, identifying shapes and colors, and even learning foreign languages.

### BRIEF DESCRIPTION OF THE DRAWINGS

FIG. 1a shows an embodiment of cup 10 according to the present invention when the cup is right side up.

FIG. 1b shows an embodiment of cup 10 according to the present invention when the cup is upside down.

FIG. 2 shows exemplary printed materials on cup 10.

FIG. 3 shows a pyramid structure that a user may build using a plurality of cups 10.

FIG. 4 shows a word pyramid that a user may building using a plurality of cups 10.

FIG. 5 shows that an embodiment of game set 60 according to the present invention.

### DETAILED DESCRIPTION OF THE INVENTION

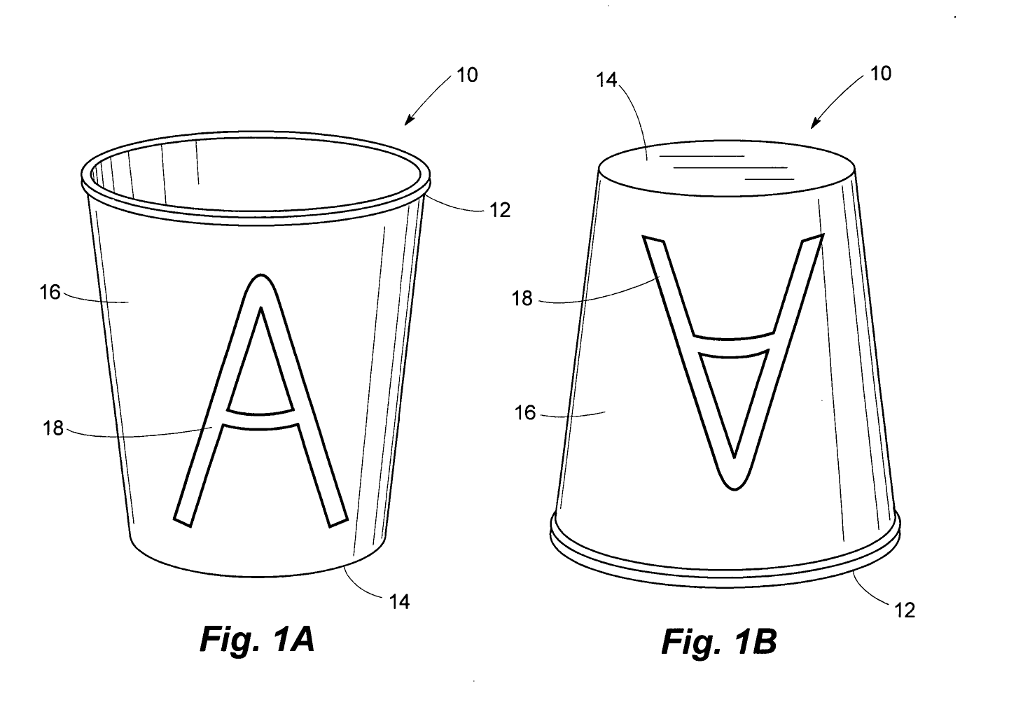

FIG. 1a shows an embodiment for an educational cup 10 according to the present invention when the cup is right side up. Cup 10 comprises a top 12, a bottom 14, a side 16, and a printed material 18 on the side 16 of the cup.

FIG. 1b shows the educational cup 10 when the cup is upside down. In particular, FIG. 1b shows that the printed material 18 is right side up when the cup 10 is upside down.

Cup 10 may be any drinkable cup of any size. However, they are preferably made from disposable materials such as paper and plastic (hereinafter “disposable”). In addition, they are preferably five (5) ounce cups.

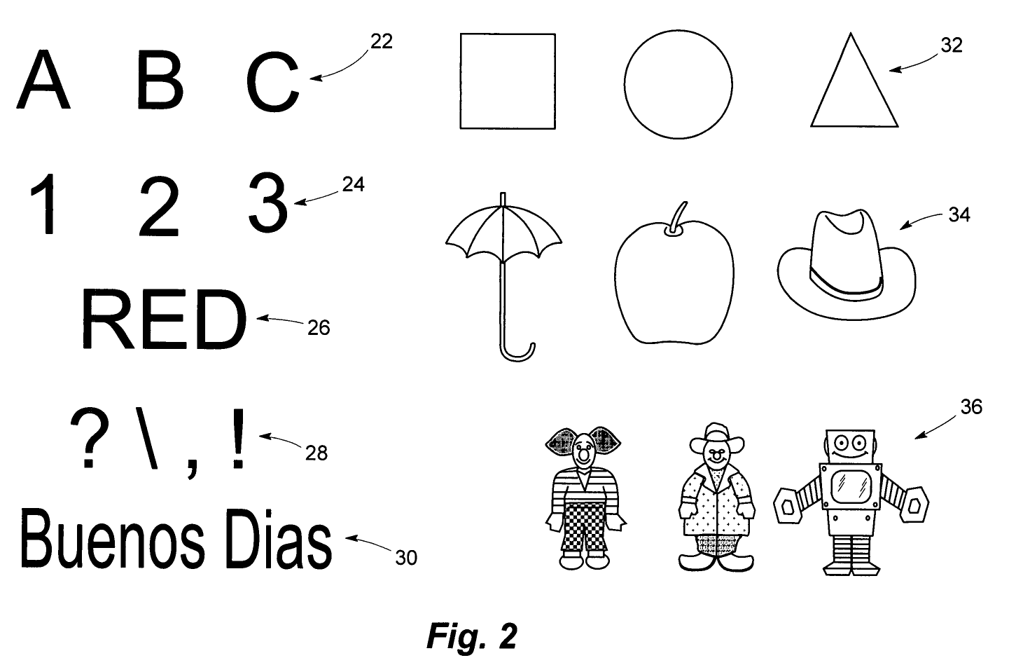

The printed material 18 on cup 10 may include any educational and fun materials for children. FIG. 2 shows various examples for printed material 18, including, among other things, letters 22, numbers 24, words 26, symbols 28, and phrases 30 (collectively, hereinafter “alphanumeric”), shapes 32, pictures 34, FIGS. 36 of animate and inanimate objects (collectively, hereinafter “shapes”). The printed material 18 may be black and white or in color.

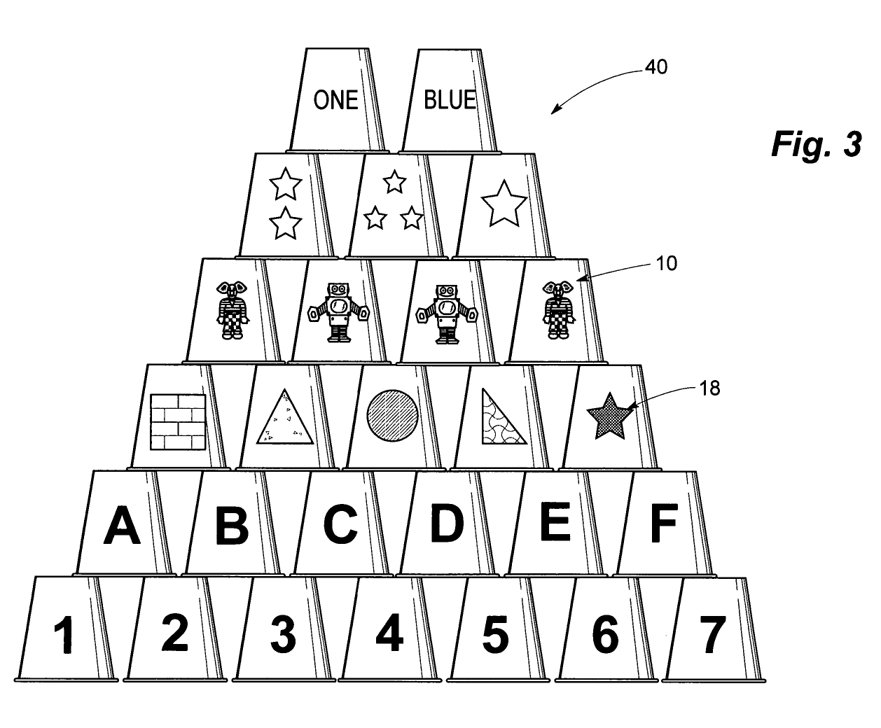

A child may stack a plurality of cups 10 to build a pyramid structure 40, as shown in FIG. 3. The pyramid structure 40 is easy to build, demolish and put away for the next time. More over, by stacking the cups 12 as regular disposable cups, a caregiver can easily carry them to any place his or her child may travel. The printed materials 18 on cups 10 engage the child's mind as she or he, among other things, stack, sort, match, and arrange them.

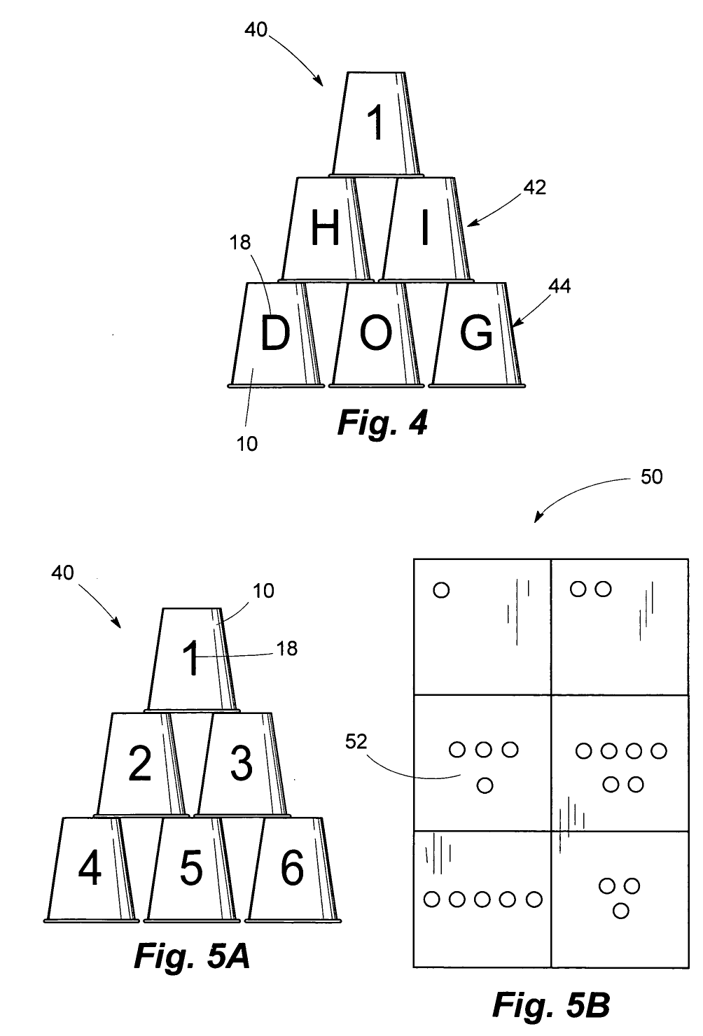

In addition, while a child is engaged with the cups 10, a caregiver can also emphasize the learning experience by bringing the printed materials 18 on the cups to the child's attention. As an example, a series of letters may be used to teach young children how to put together words, such as “hi” 42 and “dog” 44, as shown in FIG. 4.

As can be appreciated by those who care for children, cups 10 according to the present invention facilitate numerous educational and fun children's activities. For example, the colors in the printed materials may be used to teach the child the names of colors; while the shapes in the printed materials may be used to teach the child the names of shapes; and the alphanumeric printed materials may be used to teach the child the opposites, rhymes, or even a foreign language.

FIG. 5 shows an embodiment for game set 60 according to the present invention, the game set comprising educational cups 10 according to the present invention and a mat 50, which includes a printed material 52. Preferably, a plurality of cups 10, thus a plurality of printed materials 18, is used with a mat having a plurality of corresponding printed materials 52. As an example, as shown in FIG. 5, a plurality of printed materials 18 forms a first number series, and a plurality of printed materials 52 forms a second series corresponding to the first series. In play, the child may engage in matching one of the items shown in the plurality of cups 10, that is, a number in the plurality of printed materials 18, with the corresponding item shown in mat 50, that is, a corresponding shape in the printed materials 52.

Again, as can be appreciated by those engaged in child caring, numerous educational and fun games may be played using cups 10 and mat 50. As an example, the first series of printed materials 18 on cups 10 may be letters of the alphabet and the second series of printed materials 52 on mat 50 may be shapes of the objects whose name starts with the letters shown on cups 10. The child is then directed find the item in the second series of printed materials 52 that starts with a letter shown on one of the cups 10. As another example, the first series of printed materials 18 may be names of colors and the second series of printed materials 52 may be colored shapes. The child is then directed to match using the colors on the cups as a guide, each cup with the corresponding item in the second series of printed materials 52. In addition, cups 10 according to the present invention may be used to play popular games such as, among other things, crosswords, scrabble, and checkers, as well as construction games, such as, among other things, build-a-house, build-a-picture, and build-a-castle. Cups 10 according to the present invention may also be used to inform children regarding events such as, among other things, Thanksgiving, Christmas, Passover, and Hanukah, as well as regarding subjects such as, among other things, zoos, flags, presidents, countries, and states. Accordingly, educational and fun play cups and games sets according to the present invention may be used for innumerable fun and stimulating activities.

Numerous modifications to and alternative embodiments of the present invention will be apparent to those skilled in the art in view of the foregoing description. Accordingly, this description is to be construed as illustrative only and is for the purpose of teaching those skilled in the art the best mode of carrying out the invention. Details of the embodiment may be varied without departing from the spirit of the invention, and the exclusive use of all modifications which come within the scope of the appended claims is reserved.

What is claimed is:

1. A cup for child's play, comprising
a cup having a top, a bottom and a side; and
a printed material on the side of the cup such that the printed material is right side up when the cup is placed upside down.

2. The cup according to claim 1, wherein the cup is made of plastic.

3. The cup according to claim 1, wherein the cup is made of paper.

4. The cup according to claim 1, wherein the printed material is alphanumeric.

5. The cup according to claim 1, wherein the printed material comprises a shape.

6. The cup according to claim 1, wherein the printed material is colored.

7. A game set for child's play, comprising
a cup having a top, a bottom and a side;
a first printed material on the side of the cup wherein the printed material is right side up when the cup is upside down;
a mat comprising a second printed material corresponding to first printed material.

8. The game set according to claim 7, wherein the first printed material is alphanumeric, and the second printed material comprises a shape.

9. The game set according to claim 7, wherein the first printed material comprises a shape, and the second printed material comprises a colored shape.
